(19) United States
(12) Patent Application Publication
(10) Pub. No.: US 2010/0092820 A1
(43) Pub. Date: Apr. 15, 2010

(54) FUEL CELL SYSTEM

(75) Inventor: Arato TAKAHASHI, Shizuoka (JP)

Correspondence Address: YAMAHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi (JP)

(21) Appl. No.: 12/575,592

(22) Filed: Oct. 8, 2009

(30) Foreign Application Priority Data
Oct. 9, 2008 (JP) 2008-263205

(51) Int. Cl. H01M 8/04

(52) U.S. Cl. 429/24; 429/22

(57) ABSTRACT

A fuel cell system capable of accurately controlling aqueous methanol solution and moisture discharged from the fuel cell, and which can be built small in size. The fuel cell system includes a radiator unit including a radiator pipe for a flow of aqueous methanol solution discharged from an anode outlet of a cell stack which includes fuel cells, and a radiator pipe for a flow of moisture discharged from a cathode outlet of the cell stack. Further, the radiator unit has an inflow passage for air to flow in, a first cooling passage branching from the inflow passage to supply the air to an outer circumference of the radiator pipe, and a second cooling passage arranged to supply the air to an outer circumference of the radiator pipe. A plate member is provided in the radiator unit to adjust a passage resistance of the first cooling passage and that of the second cooling passage.

### BACKGROUND OF THE INVENTION

1. Field of the Invention

The present invention relates to a fuel cell system, and more specifically to a fuel cell system which includes two radiators, i.e., an aqueous solution radiator and a gas-liquid separation radiator.

2. Description of the Related Art

WO 2005/004267 discloses a fuel cell system which includes two radiators, i.e., an aqueous solution radiator for cooling aqueous methanol solution as a fuel, and a gas-liquid separation radiator for condensation and collection of water vapor produced by reactions in the fuel cells.

In a fuel cell system such as that described above, it is preferable to provide an independent control to a fan which controls the cooling capacity of the aqueous solution radiator based on such conditions as temperature and output of the fuel cell, and an independent control to a fan which controls the cooling capacity of the gas-liquid separation radiator based on such conditions as the amount of collected water and outside air temperature.

However, in cases where the two fans are controlled independently, there can be a situation where one of the fans is stopped, the radiator which belongs to that fan warms the ambient air, and this warmed air is picked up by the other fan and is supplied to the other radiator which belongs to the other fan. This makes it impossible to provide accurate control of the cooling capacities of the radiators, i.e., the capacities to cool aqueous fuel solution and moisture which are discharged from the fuel cell.

In order to prevent this problem, it is necessary to provide an independent cooling air passage for each of the radiators and to dispose two cooling air intake openings for the respective air passages remotely from the radiators. However, this arrangement requires long cooling air passages, resulting in increased size of the apparatus.

### SUMMARY OF THE INVENTION

In view of the above problems, preferred embodiments of the present invention provide a fuel cell system which is capable of accurately controlling the aqueous fuel solution and moisture discharged from the fuel cell yet can be built small in size.

According to a preferred embodiment of the present invention, a fuel cell system includes a fuel cell having an anode and a cathode; a first pipe for a flow of aqueous fuel solution discharged from the anode of the fuel cell; a second pipe for a flow of moisture discharged from the cathode of the fuel cell; a cooling passage having an inflow passage for an inflow of a fluid to cool the first pipe and the second pipe, a first cooling passage branching from the inflow passage and arranged to supply the fluid to an outer circumference side of the first pipe and a second cooling passage branching from the inflow passage and arranged to supply the fluid to an outer circumference side of the second pipe; an adjusting mechanism arranged to adjust passage resistances of the first cooling passage and the second cooling passage in the cooling passage; and a controller arranged to control the adjusting mechanism.

In a preferred embodiment of the present invention, the first cooling passage and the second cooling passage are provided independently from each other branching from the inflow passage in the cooling passage, and the passage resistance of each cooling passage is adjusted by the adjusting mechanism. With this adjustment, the fluid flows from the inflow passage toward the first cooling passage and the second cooling passage, and therefore the outer circumference side of the first pipe and the outer circumference side of the second pipe are supplied with their respective amounts of the fluid flow in accordance with their passage resistances. In this case, even if the inflow passage in the cooling passage is short, there is no case where the fluid which has once entered one of the first cooling passage and the second cooling passage flows into the other. Hence, it is possible, for example, to prevent a case where the fluid which has been warmed in one of the cooling passages is supplied to the other cooling passage. Therefore, it becomes possible to accurately control the cooling capacities of the first pipe and the second pipe, i.e., the capacities to cool aqueous fuel solution and moisture discharged from the fuel cell. Also, the arrangement makes it possible to give a short distance from the entrance of the cooling passage to the entrance of the first cooling passage or the second cooling passage, i.e., the length of the inflow passage may be short. This makes it possible to reduce the size of the apparatus.

Preferably, the fuel cell system further includes a fluid supply unit arranged to supply the fluid to the outer circumference side of the first pipe and to the outer circumference side of the second pipe. In this case, it is possible to accelerate the fluid supply to the first cooling passage and the second cooling passage by driving the fluid supply unit, such as a fan, for example. Also, by adjusting the passage resistance of each cooling passage, the amount of fluid to be supplied to each of the outer circumference side of the first pipe and the outer circumference side of the second pipe can be adjusted. Thus, there is no need to provide the fluid supply unit for each of the cooling passages and the fluid supply unit can be shared by the cooling passages. Therefore, the present invention is free from noise problems such as those caused by a plurality of fans which are provided in mutual proximity to each other in their respective cooling passages. In addition, the present invention makes it possible to reduce power consumption.

Further preferably, the adjusting mechanism includes a plate member arranged in the cooling passage to adjust the passage resistances; and a driving mechanism arranged to move the plate member. In this case, the passage resistance can be adjusted easily by simply moving the plate member via the driving mechanism.

Further, preferably, the fuel cell system further includes a liquid temperature obtaining unit arranged to obtain liquid temperature information regarding a temperature of the aqueous fuel solution; a collecting unit arranged to collect water contained in the moisture; and a water amount obtaining unit arranged to obtain water amount information regarding an amount of water in the collecting unit. With this arrangement, the controller controls the adjusting mechanism based on the liquid temperature information obtained by the liquid temperature obtaining unit and the water amount information obtained by the water amount obtaining unit. By controlling the adjusting mechanism based on the liquid temperature information regarding a temperature of the aqueous fuel solution as well as the water amount information regarding an amount of water in the collecting unit thereby adjusting the passage resistances of the first cooling passage and the second cooling passage, the capacity to cool the aqueous fuel solution and the capacity to separate the moisture into gas and liquid can be adjusted easily.

Preferably, the controller controls the adjusting mechanism so that the passage resistance of the first cooling passage is greater than the passage resistance of the second cooling passage when the temperature indicated by the liquid temperature information is lower than a first threshold value. When the liquid temperature indicated by the liquid temperature information is lower than the first threshold value, i.e., when the temperature of aqueous fuel solution is low, there is no need to accelerate cooling of the aqueous fuel solution. Thus, the passage resistance of the first cooling passage is made greater than the passage resistance of the second cooling passage so that the fluid will flow more easily to the second cooling passage. This slows down cooling of the aqueous fuel solution while accelerating the gas-liquid separation of the moisture and facilitating water collection.

Further preferably, the fuel cell system further includes a fluid supply unit arranged to supply the fluid to the outer circumference side of the first pipe and to the outer circumference side of the second pipe. With this arrangement, the controller stops the fluid supply unit if the amount of water indicated by the water amount information is not smaller than a second threshold value. On the other hand, the controller drives the fluid supply unit if the amount of water indicated by the water amount information is smaller than the second threshold value. As described, if the amount of water indicated by the water amount information is not smaller than the second threshold value, there is no need to accelerate water collection, and thus the fluid supply unit is stopped. On the other hand, if the amount of water indicated by the water amount information is smaller than the second threshold value, the fluid supply unit is driven in order to accelerate water collection. As described above, it is possible to control the operation of the fluid supply unit in accordance with the amount of water in the collecting unit, so that adjustment is made on the amount of water collection.

Further, preferably, the controller controls the adjusting mechanism so that the passage resistance of the first cooling passage is smaller than the passage resistance of the second cooling passage if the temperature indicated by the liquid temperature information is not lower than a first threshold value and the amount of water indicated by the water amount information is not smaller than a second threshold value. As described, when the liquid temperature indicated by the liquid temperature information is not lower than the first threshold value and the amount of water indicated by the water amount information is not smaller than the second threshold value, i.e., when the temperature of the aqueous fuel solution is high and the amount of water in the collecting unit is large, the passage resistance of the first cooling passage is made smaller than the passage resistance of the second cooling passage. This makes it possible to accelerate cooling of the aqueous fuel solution while slowing down gas-liquid separation of the moisture.

Preferably, the controller controls the adjusting mechanism so that the passage resistance of the first cooling passage and the passage resistance of the second cooling passage become substantially equal to each other if the temperature indicated by the liquid temperature information is not lower than a first threshold value and the amount of water indicated by the water amount information is smaller than a second threshold value. As described, when the liquid temperature indicated by the liquid temperature information is not lower than the first threshold value and the amount of water indicated by the water amount information is smaller than the second threshold value, i.e., when the temperature of the aqueous fuel solution is high and the amount of water in the collecting unit is small, the adjusting mechanism makes the passage resistance of the first cooling passage and that of the second cooling passage substantially equal to each other. This makes it possible to perform gas-liquid separation to the moisture and collect water while cooling the aqueous fuel solution.

Further preferably, the fuel cell system further includes a fluid supply unit arranged to supply the fluid to the outer circumference side of the first pipe and to the outer circumference side of the second pipe. With this arrangement, the controller controls the fluid supply unit based on the liquid temperature information obtained by the liquid temperature obtaining unit. In this case, if the temperature of aqueous fuel solution is low, supply capacity of the fluid supply unit is reduced to decrease the fluid supply to the first cooling passage, thereby raising the temperature of aqueous fuel solution. On the other hand, if the temperature of the aqueous fuel solution is high, the supply capacity of the fluid supply unit is raised to accelerate the fluid supply to the first cooling passage, thereby lowering the temperature of aqueous fuel solution.

Further, preferably, the controller controls the adjusting mechanism based on an amount of water collection if the liquid temperature indicated by the liquid temperature information is not lower than a first threshold value and the amount of water indicated by the water amount information is smaller than a second threshold value. In this case, if the amount of water collection is small, the adjusting mechanism decreases the passage resistance of the second cooling passage, thereby accelerating water collection. On the other hand, if the amount of water collection is large, the adjusting mechanism increases the passage resistance of the second cooling passage, thereby slowing down the water collection.

Preferably, the fuel cell system further includes a fluid temperature obtaining unit arranged to obtain fluid temperature information regarding a temperature of the fluid; and a fluid supply unit arranged to supply the fluid to the outer circumference side of the first pipe and to the outer circumference side of the second pipe. With this arrangement, the controller controls the fluid supply unit based on the liquid temperature information obtained by the liquid temperature obtaining unit and the fluid temperature information obtained by the fluid temperature obtaining unit. The larger the value of the “temperature of aqueous fuel solution minus temperature of the fluid”, the more effectively the aqueous fuel solution can be cooled by the fluid, whereas the smaller the value of the “temperature of aqueous fuel solution minus temperature of the fluid”, the lower the effect of cooling the aqueous fuel solution by the fluid is. Therefore, if the “temperature of aqueous fuel solution minus temperature of the fluid” has a large value, the supply capacity of the fluid supply unit is lowered to decrease the amount of fluid supply to the first cooling passage, thereby stabilizing the capacity to cool aqueous fuel solution. On the other hand, if the “temperature of aqueous fuel solution minus temperature of the fluid” has a small value, the supply capacity of the fluid supply unit is raised to increase the amount of fluid supply to the first cooling passage, thereby stabilizing the capacity to cool aqueous fuel solution.

Further preferably, the controller controls the adjusting mechanism based on an amount of water collection and an amount of water consumption if the liquid temperature indicated by the liquid temperature information is not lower than a first threshold value and the amount of water indicated by the water amount information is smaller than a second threshold value. In this case, if the “amount of collection minus amount of consumption” of water has a large value, the adjusting mechanism increases the passage resistance of the second cooling passage and decreases the passage resistance of the first cooling passage so that the amount of water to be collected is decreased. On the other hand, if the “amount of collection minus amount of consumption” of water has a small value, the adjusting mechanism decreases the passage resistance of the second cooling passage and increases the passage resistance of the first cooling passage so that water collection is accelerated.

Further, preferably, the fuel cell system further includes a fluid temperature obtaining unit arranged to obtain fluid temperature information regarding a temperature of the fluid; a plate member arranged to be displaceable in the cooling passage so as to adjust the passage resistance; and a fluid supply unit arranged to supply the fluid to the outer circumference side of the first pipe and to the outer circumference side of the second pipe. With this arrangement, the controller controls the fluid supply unit based on the liquid temperature information obtained by the liquid temperature obtaining unit, the fluid temperature information obtained by the fluid temperature obtaining unit and a position of the plate member. In this case, the amount of fluid to be supplied to the first cooling passage is obtained on the basis of the “temperature of aqueous fuel solution minus temperature of the fluid”, and then the supply capacity of the fluid supply unit which is required to achieve the supply amount is obtained on the basis of the position of the plate member. If the capacity to cool aqueous fuel solution is to be maintained at a constant level, for example, the larger the value of the “temperature of aqueous fuel solution minus temperature of the fluid”, the less the amount of the fluid which must be supplied to the first cooling passage. On the other hand, the smaller the value of the “temperature of aqueous fuel solution minus temperature of the fluid”, the greater the amount of the fluid which must be supplied to the first cooling passage. Then, based on the amount of the fluid which must be supplied and the position of the plate member, the supply capacity of the fluid supply unit is determined. This makes it possible to further stabilize the capability to cool aqueous fuel solution.

In the present invention, a term “passage resistance” means a level of difficulty for a fluid to flow in a passage.

Also, the term “moisture” is a concept which includes water in the liquid form and water in the gaseous form (water vapor).

The above-described and other elements, steps, features, characteristics, aspects and advantages of the present invention will become clearer from the following detailed description of preferred embodiments of the present invention with reference to the drawings.

### BRIEF DESCRIPTION OF THE DRAWINGS

FIG. 1 is a perspective view of a fuel cell system according to a preferred embodiment of the present invention.

FIG. 2 is a perspective view of an example of a radiator unit.

FIG. 3 is a general configuration diagram showing elements of the fuel cell system according to a preferred embodiment of the present invention.

FIG. 4 is an electrical block diagram of the fuel cell system according to a preferred embodiment of the present invention.

FIG. 5 is an explanatory diagram of an example of radiator unit.

FIG. 6 is a flowchart showing an example of operation of the fuel cell system.

FIG. 7 a flowchart showing another example of operation of the fuel cell system.

FIG. 8 a flowchart showing still another example of operation of the fuel cell system.

FIG. 9 is a graph showing a corresponding relationship between “temperature of aqueous methanol solution minus ambient temperature” and the number of revolutions of a fan.

FIG. 10 a graph showing a corresponding relationship between “amount of collection minus amount of consumption” of water per unit time and a ratio of the amount of air on an aqueous solution radiator side.

FIG. 11 is a graph showing a corresponding relationship between “temperature of aqueous methanol solution minus ambient temperature” and the amount of air required for the aqueous solution radiator.

FIG. 12A through FIG. 12D are explanatory diagrams showing variations of a plate member.

### DETAILED DESCRIPTION OF THE PREFERRED EMBODIMENTS

Hereinafter, preferred embodiments of the present invention will be described with reference to the drawings.

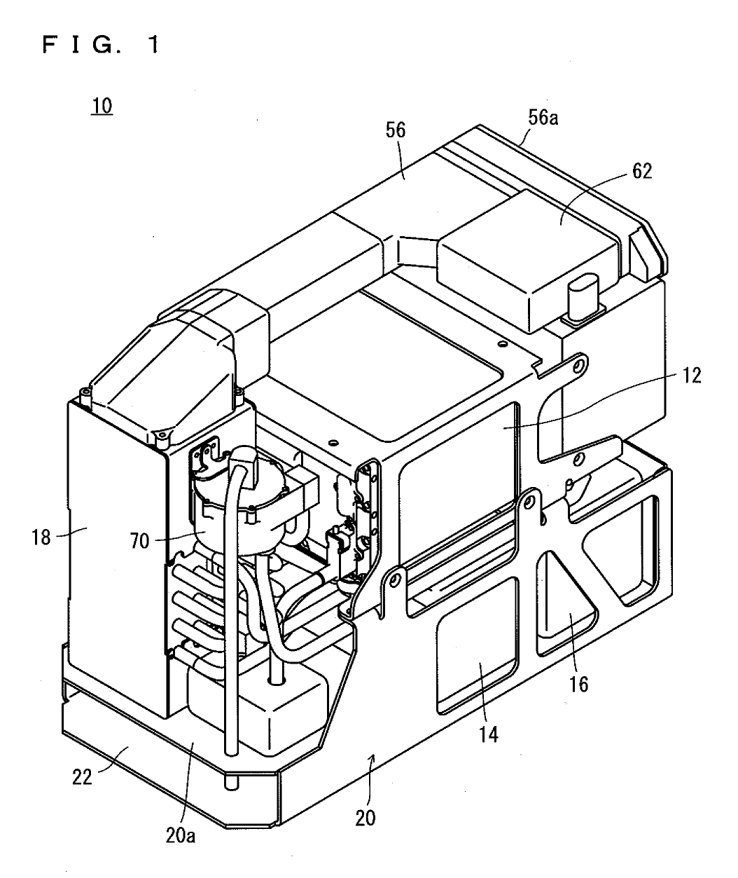

Referring to FIG. 1, a fuel cell system 10 according to a preferred embodiment of the present invention is a direct methanol fuel cell system which uses methanol (aqueous methanol solution) directly for generation of electric energy (power generation) without a refining process. FIG. 1 is a perspective view of the fuel cell system 10. The fuel cell system 10 is designed as a portable system for use in an outdoor music concert, for example, as a power supply for electronic instruments such as audio equipment. As a power generator, the fuel cell system 10 has a weight of approximately 25 kg and a maximum output of approximately 1 kW, for example.

The fuel cell system 10 includes a fuel-cell cell stack (hereinafter simply called cell stack) 12, an aqueous solution tank 14 and a water tank 16 provided below the cell stack 12, and a radiator unit 18 provided on a side of the cell stack 12. The cell stack 12, the aqueous solution tank 14 and the water tank 16 are held by a frame 20, and the radiator unit 18 is placed on a double floor 20a of the frame 20. The radiator unit 18 is placed on an upper floor of the double floor 20a, and the upper floor has an opening for the radiator unit 18 to discharge exhaust gas. The double floor 20a has a space between the two floors, serving as an exhaust port 22.

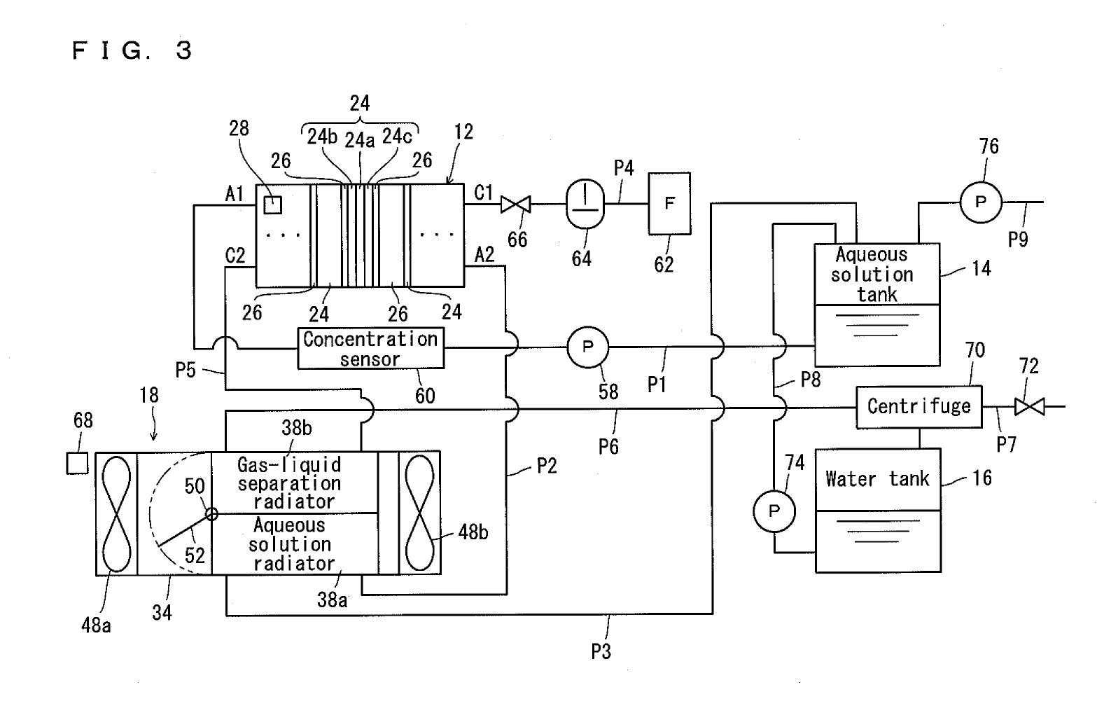

FIG. 3 is a general configuration diagram showing elements of the fuel cell system 10.

Referring to FIG. 3, the cell stack 12 includes a plurality of fuel cells (fuel-cell cells) 24 each capable of generating electricity through electrochemical reactions between hydrogen ions based on methanol and oxygen (oxidizer). The fuel cells 24 are stacked one on another, with a separator 26 placed between two mutually adjacent fuel cells 24. Each fuel cell 24 includes an electrolyte film 24a provided by a solid polymer film, for example, and a pair of an anode (fuel electrode) 24b and a cathode (air electrode) 24c which are opposed to each other with the electrolyte film 24a in between. Each of the anode 24b and the cathode 24c includes a platinum catalyst layer provided on their side which faces the electrolyte film 24a. The cell stack 12 has an anode inlet A1, near which a temperature sensor 28 is provided to detect a temperature of aqueous methanol solution which represents the temperature of the cell stack 12.

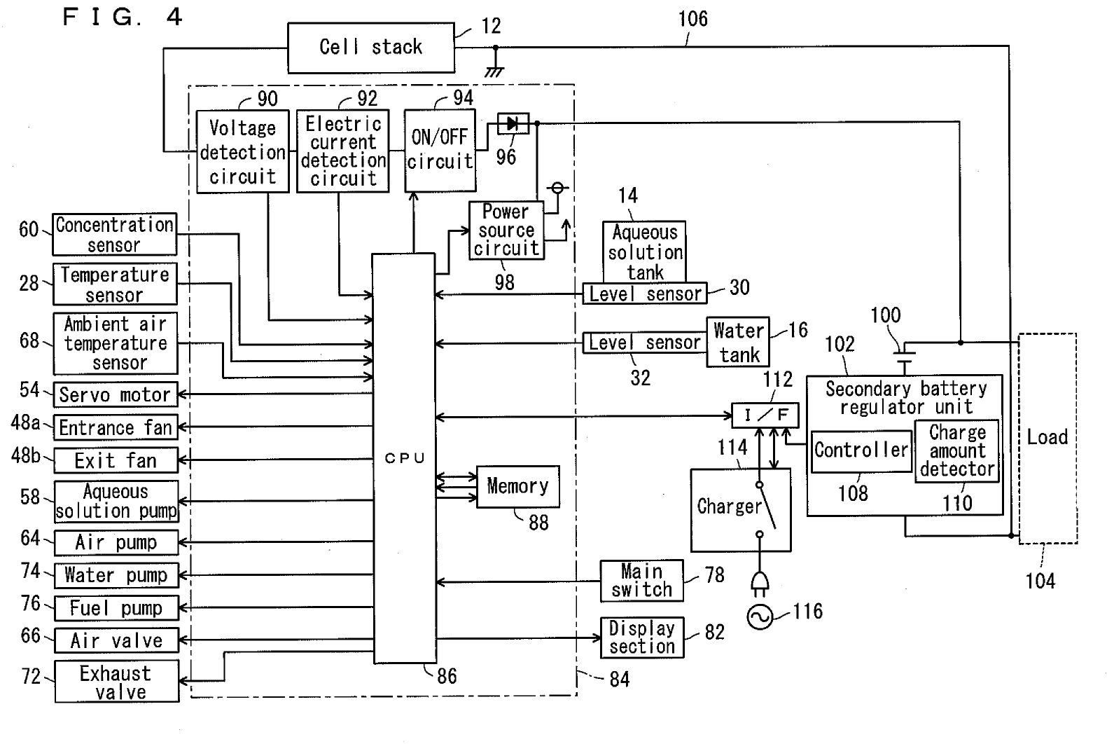

The aqueous solution tank 14 contains aqueous methanol solution which has a concentration (containing methanol at approximately 3 wt %, for example) appropriate for the electrochemical reactions in the cell stack 12, and inside the aqueous solution tank 14, there is provided a level sensor 30 (see FIG. 4) for detecting a liquid level.

The water tank 16 contains water to be supplied to the aqueous solution tank 14, and inside the water tank 16 there is provided a level sensor 32 (see FIG. 4) to detect a liquid level.

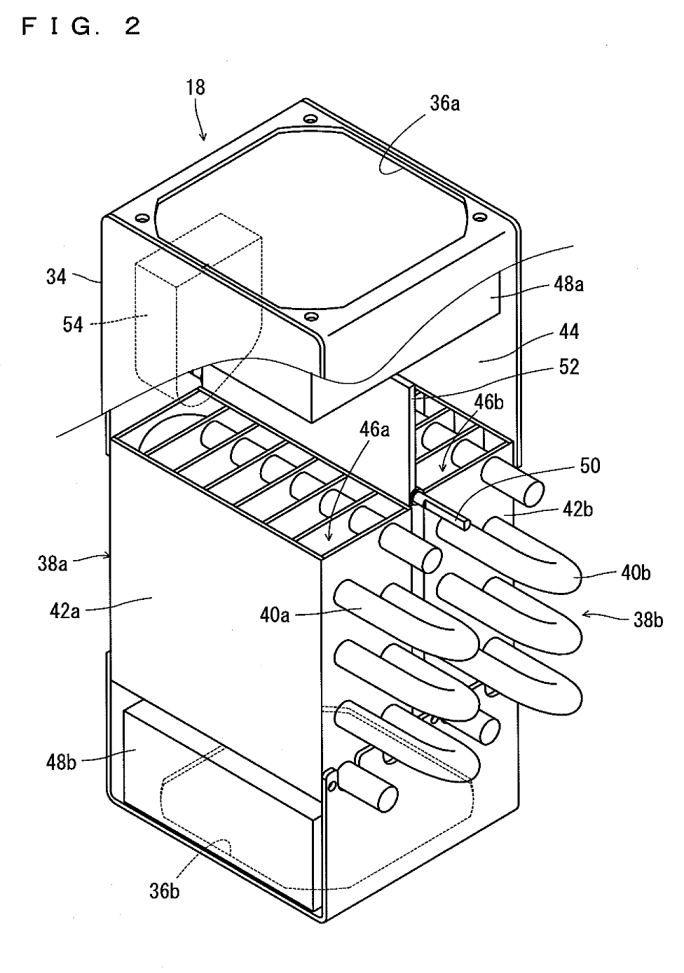

FIG. 2 is a perspective view of the radiator unit 18.

Referring also to FIG. 2, the radiator unit 18 includes a case 34 which is like a hollow square pipe, for example. The case 34 has an upper surface and a lower surface which have openings 36a and 36b, respectively. Air flows in from the opening 36a in the upper surface of the case 34 whereas air flows out from the opening 36b in the lower surface of the case 34. In a middle portion but slightly lower position in the case 34, an aqueous solution radiator 38a and a gas-liquid separation radiator 38b are arranged one next to the other in a direction perpendicular or substantially perpendicular to the longitudinal direction of the case 34. The radiator 38a includes a radiator pipe 40a and a fin member 42a made of stainless steel, for example. The radiator pipe 40a is formed into a spiral, for example. The fin member 42a includes a plurality of plate fins extending in the longitudinal direction of the case 34. Likewise, the radiator 38b includes a radiator pipe 40b and a fin member 42b made of stainless steel, for example. The radiator pipe 40b is formed into a spiral, for example, and the fin member 42b includes a plurality of plate fins extending in the longitudinal direction of the case 34. It should be noted here that although FIG. 2 shows each of the fin members 42a and 42b to include eight fins, for example, for reasons of descriptive convenience. Actually however, each of the fin members 42a and 42b may preferably include hundreds of fins, e.g., two hundred fins, in a preferred embodiment.

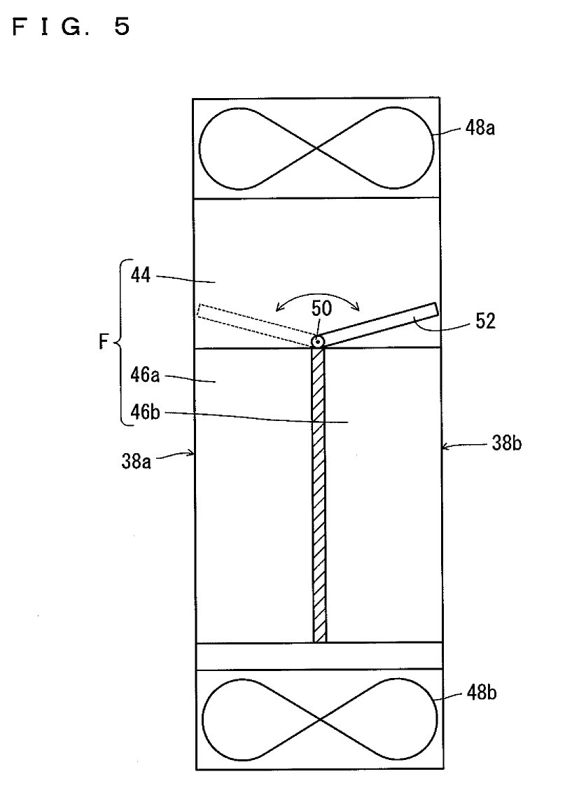

Referring also to FIG. 5, in the present preferred embodiment, a space between the opening 36a and the radiators 38a, 38b provides an air inflow passage 44 to introduce air, whereas spaces inside the fin member 42a of the aqueous solution radiator 38a and spaces inside the fin member 42b of the gas-liquid separation radiator 38b provide a first cooling passage 46a and a second cooling passage 46b, respectively. Therefore, inside the radiator unit 18, the inflow passage 44, the first cooling passage 46a and the second cooling passage 46b provides a cooling passage F. FIG. 5 is an explanatory diagram of the radiator unit 18.

Inside the case 34, at its two longitudinal end portions, an entrance fan 48a and an exit fan 48b for cooling the radiators are arranged to face the openings 36a and 36b, respectively. Therefore, the entrance fan 48a is provided on an upstream side of the first cooling passage 46a and the second cooling passage 46b whereas the exit fan 48b is provided on a downstream side thereof.

A pivot shaft 50 is provided on a border of the upper surface of the radiator 38a and the upper surface of the radiator 38b. The pivot shaft 50 supports a plate member 52 pivotably inside the inflow passage 44. The plate member 52 is provided between the entrance fan 48a and the radiators 38a, 38b.

On an outer side surface of the case 34, a servo motor 54 is provided at a position corresponding to the pivot shaft 50. The pivot shaft 50 is pivoted by a servo motor 54 which is controlled by a controller 84 (see FIG. 4), and accordingly the plate member 52 is pivoted to a selected set position (inclination). The position of the plate member 52 controls an air supply ratio to the radiators 38a and 38b, i.e., the passage resistances in the first cooling passage 46a and the second cooling passage 46b. The position of the plate member 52 is detected by an unillustrated position detection sensor. The position detection sensor is provided by, for example, a potentiometer or a pulse encoder incorporated in the servo motor 54.

As shown in FIG. 1, an air duct 56 is provided in the opening 36a of the radiator unit 18 to introduce air into the inflow passage 44. As the entrance fan 48a and the exit fan 48b are driven, air comes in from an air inlet 56a of the air duct 56, and flows into the inflow passage 44 via the opening 36a and the entrance fan 48a. The introduced air cools the radiator pipe 40a and/or 40b in the first cooling passage 46a and/or the second cooling passage 46b, and then is discharged from the exhaust port 22 via the exit fan 48b and the opening 36b.

As shown in FIG. 3, the anode inlet A1 of the cell stack 12 is connected with the aqueous solution tank 14 via a pipe P1. The pipe P1 connects, starting from the aqueous solution tank 14, an aqueous solution pump 58 and the concentration sensor 60 in this order. As the aqueous solution pump 58 is driven, aqueous methanol solution in the aqueous solution tank 14 is supplied to the cell stack 12. The concentration sensor 60 is provided by an ultrasonic sensor, for example. The ultrasonic sensor is used for detecting the concentration of aqueous methanol solution based on the principle that the traveling speed of ultrasonic waves in aqueous methanol solution varies depending on the concentration of the aqueous methanol solution.

The cell stack 12 has an anode outlet A2, where the aqueous solution tank 14 is connected via a pipe P2, the aqueous solution radiator 38a and a pipe P3. Carbon dioxide and unused aqueous methanol solution discharged from the anode outlet A2 of the cell stack 12 are supplied to the radiator 38a and cooled there.

The cell stack 12 has a cathode inlet C1, where an air filter 62 is connected via a pipe P4. The air filter 62 is supplied with air from the air inlet 56a of the air duct 56 (see FIG. 1). The pipe P4 connects, starting from the air filter 62, an air pump 64 and an air valve 66 in this order. As the air pump 64 is driven, external air which contains oxygen (oxidizer) is sent from the air inlet 56a, through the air filter 62, the air pump 64 and the air valve 66, to the cathode 24c in the cell stack 12. An ambient air temperature sensor 68 to detect an ambient temperature is provided in an outer surface of the air duct 56, at a discretionary position between the air inlet 56a and the location of connection with the radiator unit 18.

The cell stack 12 has a cathode outlet C2, where the water tank 16 is connected via a pipe P5, the gas-liquid separation radiator 38b, a pipe P6 and a centrifuge 70. The cathode outlet C2 of the cell stack 12 discharges exhaust gas which contains moisture (including water and water vapor), carbon dioxide and unused air. The exhaust gas is supplied to the radiator 38b and cooled there. The centrifuge 70 is connected with an exhaust pipe P7, and the exhaust pipe P7 leads to an exhaust valve 72. The centrifuge 70 applies a centrifugal force to the exhaust gas from the radiator 38b, thereby separating water from the exhaust gas. The separated water is supplied to the water tank 16. The exhaust gas is discharged from the exhaust pipe P7 when the exhaust valve 72 is open.

Also, the water tank 16 is connected with the aqueous solution tank 14 via a pipe P8. The pipe P8 leads to a water pump 74. As the water pump 74 is driven, water in the water tank 16 is supplied to the aqueous solution tank 14.

The aqueous solution tank 14 can be connected with an external fuel tank (not illustrated) via a pipe P9. The pipe P9 leads to a fuel pump 76. The external fuel tank contains high concentration methanol fuel, i.e., high concentration aqueous methanol solution (containing methanol at approximately 50 wt %, for example) as a fuel for the electrochemical reactions in the cell stack 12, and is connected with the pipe P9 as needed. With the external fuel tank connected with the pipe P9 and the fuel pump 76 being driven, the methanol fuel in the external fuel tank is supplied to the aqueous solution tank 14.

FIG. 4 is a block diagram which shows an electric configuration of the fuel cell system 10.

Referring to FIG. 4, the fuel cell system 10 further includes a main switch 78, a display section 82 and the controller 84.

As the main switch 78 is turned on, an operation start command is given to the controller 84, and as the main switch 78 is turned off, an operation stop command is given to the controller 84. The display section 82 displays various kinds of information.

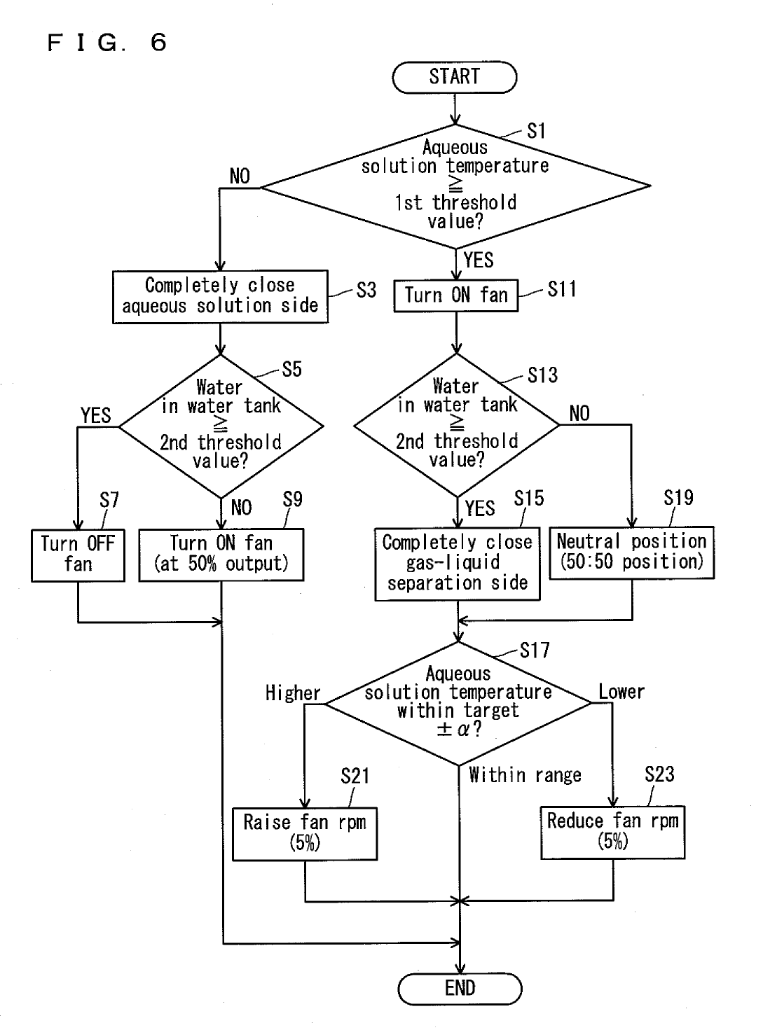

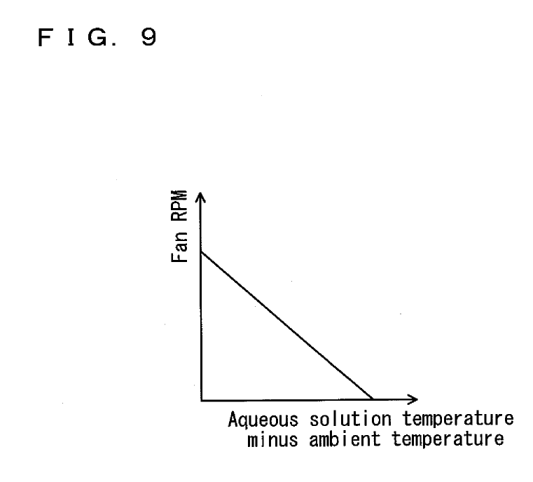

The controller 84 includes a CPU 86, a memory 88, a voltage detection circuit 90, an electric current detection circuit 92, an ON/OFF circuit 94, a diode 96 and a power source circuit 98. The CPU 86 performs necessary calculations and controls operations of the fuel cell system 10. The memory 88, which serves as storage device, is preferably provided by an EEPROM, for example, and stores programs, data, calculation data, etc., to control the operations of the fuel cell system 10. Specifically, the memory 88 stores programs for execution of operations shown in FIG. 6 through FIG. 8, and data shown in FIG. 9 through FIG. 11, and others.

The voltage detection circuit 90 detects a voltage in an electric circuit 106 which connects the cell stack 12 with a secondary battery 100, a secondary battery regulator unit 102 and a load 104. The electric current detection circuit 92 detects an electric current which flows through the electric circuit 106. The ON/OFF circuit 94 switches between open/close states of the electric circuit 106. The power source circuit 98 supplies a predetermined voltage to the electric circuit 106.

The secondary battery 100, which is connectable and disconnectable to and from the electric circuit 106, i.e., the fuel cell system 10, stores electric power from the cell stack 12 as well as supplies electric power to the load 104 and to electric components in response to commands from the controller 84. The secondary battery regulator unit 102 includes a controller 108 which controls the load 104; and a charge amount detector 110 which detects an amount of charge in the secondary battery 100; and communicates with the controller 84 via an interface circuit 112. Also, the secondary battery 100 is connected with a charger 114 via the interface circuit 112 so it can be charged with an external power source 116.

In the fuel cell system 10 as described above, the CPU 86 of the controller 84 is supplied with an input signal from the main switch 78. Also, the CPU 86 is supplied with detection signals from the level sensors 30, 32, the concentration sensor 60, the temperature sensor 28 and the ambient air temperature sensor 68. Further, the CPU 86 is supplied with a detected voltage value from the voltage detection circuit 90 and a detected current value from the electric current detection circuit 92.

The CPU 86 controls system components such as the servo motor 54, the entrance fan 48a, the exit fan 48b, the aqueous solution pump 58, the air pump 64, the water pump 74, the fuel pump 76, the air valve 66 and the exhaust valve 72. The CPU 86 also controls the display section 82. In the present preferred embodiment, the term “system components” refer to those components which are necessary for maintaining power generation in the cell stack 12. The term “load 104” refers to those components which consume electric power other than the system components which are necessary for maintaining power generation in the cell stack 12. The load 104 includes any equipment (audio equipment, for example).

In the present preferred embodiment, the adjusting mechanism preferably includes the pivot shaft 50, the plate member 52 and the servo motor 54. The controller preferably includes the CPU 86. The fluid supply unit preferably includes the entrance fan 48a and the exit fan 48b. The driving unit preferably includes the pivot shaft 50 and the servo motor 54. The temperature sensor 28 represents the liquid temperature obtaining unit. The water tank 16 represents the collecting unit. The water amount obtaining unit includes the level sensor 32. The ambient air temperature sensor 68 represents the fluid temperature obtaining unit. The radiator pipe 40a represents the first pipe whereas the radiator pipe 40b represents the second pipe.

Next, reference will be made to FIG. 6 to describe an example of operation relevant to the radiator unit 18 of the fuel cell system 10.

First, the CPU 86 determines whether or not a temperature of aqueous methanol solution detected by the temperature sensor 28 is not lower than a first threshold value (approximately 60° C., for example) (Step S1). If the temperature of the aqueous methanol solution is lower than the first threshold value, the CPU 86 controls the servo motor 54 to pivot the plate member 52 toward the aqueous solution radiator 38a, and thereby causes the plate member 52 to completely close an intake opening of the aqueous solution radiator 38a (Step S3).

Next, the CPU 86 determines whether or not the amount of water in the water tank 16 is not lower than a second threshold value (about 0.5 liter, for example) (Step S5). This is determined on the basis of a value detected by the level sensor 32. If the amount of water in the water tank 16 is not lower than the second threshold value, there is no need to accelerate water collection. Therefore, the CPU 86 stops the entrance fan 48a and the exit fan 48b (Step S7). On the other hand, if the amount of water in the water tank 16 is lower than the second threshold value, the CPU 86 drives the entrance fan 48a and the exit fan 48b at about 50% of their rated output capacities (about 50% of their rated rpms), for example (Step S9) in order to accelerate water collection, and the process comes to an end. It should be noted here that in the present preferred embodiment, the entrance fan 48a and the exit fan 48b are preferably set to rotate at the same rpm. Since the entrance fan 48a and the exit fan 48b are not disposed in mutual proximity, they are not likely to produce “beat noise” when they rotate at different speeds from each other. However, driving the two at the same rotation speed eliminates the problem of “beat noise”.

If the temperature of the aqueous methanol solution is not lower than the first threshold value in Step S1, the entrance fan 48a and the exit fan 48b are driven (Step S11), and the CPU 86 determines whether or not the amount of water in the water tank 16 is not lower than the second threshold value (Step S13). If the amount of water in the water tank 16 is not lower than the second threshold value, the CPU 86 controls the servo motor 54 to pivot the plate member 52 toward the gas-liquid separation radiator 38b, and thereby causes the plate member 52 to completely close an intake opening of the gas-liquid separation radiator 38b (Step S15) in order to reduce the amount of water in the water tank 16, and the process proceeds to Step S17. On the other hand, if Step S13 determines that the amount of water in the water tank 16 is lower than the second threshold value, the CPU 86 controls the servo motor 54 to move the plate member 52 to a neutral position (the position where a 50:50 air flow ratio is achieved between the amount of air which flows toward the aqueous solution radiator 38a and the amount which flows toward the gas-liquid separation radiator 38b) (Step S19), and the process proceeds to Step S17.

In Step S17, the CPU 86 determines whether or not the temperature of the aqueous methanol solution is within a range defined by a target value ±α (within about 65° C.±5° C., for example). If the temperature of the aqueous methanol solution is within the target value ±α, the process comes to an end. If the temperature of the aqueous methanol solution is higher than the target value +α (about 70° C., for example), the CPU 86 takes a step to lower the temperature of the aqueous methanol solution by increasing the rpm of the entrance fan 48a and the exit fan 48b by about 5%, for example (Step S21). On the other hand, if the temperature of the aqueous methanol solution is lower than the target value −α (about 60° C., for example), the CPU 86 takes a step to raise the temperature of the aqueous methanol solution by decreasing the rpm of the entrance fan 48a and the exit fan 48b by about 5%, for example (Step S23). As described, the process adjusts the rpm of the entrance fan 48a and the exit fan 48b so that the temperature of the aqueous methanol solution will be within the target value ±α, and then the process comes to an end.

The operation shown in FIG. 6 is performed repeatedly at a predetermined interval.

According to the fuel cell system 10 as described above, the radiator unit 18 has the cooling passage F within itself, where the inflow passage 44 branches into the first cooling passage 46a and the second cooling passage 46b which are independent from each other, and the position of the plate member 52 adjusts the passage resistance in each of the cooling passages 46a and 46b. With this adjustment, air flows from the inflow passage 44 toward the first cooling passage 46a and the second cooling passage 46b, and therefore the outer circumference of the radiator pipe 40a and the outer circumference of the radiator pipe 40b are supplied with their respective amounts of air flow in accordance with their passage resistances. In this case, even if the inflow passage 44 in the cooling passage F is short, there is no case where air which has once entered in one of the first cooling passage 46a and the second cooling passage 46b flows into the other. Hence, it is possible, for example, to prevent a case where air warmed in one of the cooling passages is supplied to the other cooling passage. Therefore, it becomes possible to accurately control the cooling capacity of the radiator pipe 40a and that of the radiator pipe 40b, i.e., capacities to cool aqueous methanol solution and moisture discharged from the cell stack 12. Also, the arrangement makes it possible to give a short distance from the opening 36a to the intake opening of the radiator 38a or 38b, i.e., the length of the inflow passage 44 can be made short. This makes it possible to reduce the size of the fuel cell system 10. Further, integration of the radiators 38a and 38b not only facilitates the size reduction of the fuel cell system 10 but also makes it possible to simplify pipe routing as a result of combining high-temperature components.

Also, it is possible to accelerate air supply to the first cooling passage 46a and the second cooling passage 46b by driving the entrance fan 48a and the exit fan 48b. Further, since it is possible to adjust the amount of air supply to each of the outer circumference of the radiator pipe 40a and the outer circumference of the radiator pipe 40b by adjusting the passage resistance of the first cooling passage 46a and that of the second cooling passage 46b, there is no need to provide the entrance fan 48a for each cooling passage, but the fan 48a can be shared by the two cooling passages 46a and 46b. The same applies to the exit fan 48b. Therefore, the present invention is free from noise problems which are common in cases where fans are provided in mutual proximity to each other in their respective cooling passages. In addition, it becomes possible to reduce power consumption.

Further, the passage resistance can be adjusted easily by simply moving the plate member 52 with the servo motor 54.

Also, the capacity to cool the aqueous methanol solution and the capacity to perform gas-liquid separation to the moisture can be adjusted easily by controlling the plate member 52 based on the temperature of the aqueous methanol solution and the amount of water in the water tank 16 thereby adjusting the passage resistance of the first cooling passage 46a and that of the second cooling passage 46b.

Specifically, when the temperature of the aqueous methanol solution is lower than the first threshold value, there is no need to accelerate cooling of the aqueous methanol solution, and therefore the intake opening of the first cooling passage 46a is closed with the plate member 52, thereby sending air only to the second cooling passage 46b. This makes it possible to slowdown cooling of the aqueous methanol solution while performing the gas-liquid separating operation to the moisture thereby collecting water. In this process, if the amount of water in the water tank 16 is not lower than the second threshold value, there is no need to accelerate water collection, so the entrance fan 48a and the exit fan 48b are stopped. On the other hand, if the amount of water in the water tank 16 is lower than the second threshold value, the entrance fan 48a and the exit fan 48b are driven, thereby accelerating water collection. As described above, it is possible to control operation of the entrance fan 48a and the exit fan 48b in accordance with the amount of water in the water tank 16, whereby adjustment is made to the amount of water to be collected.

On the other hand, if the temperature of the aqueous methanol solution is not lower than the first threshold value and the amount of water in the water tank 16 is not lower than the second threshold value, the plate member 52 closes the intake opening of the second cooling passage 46b, allowing air to flow only into the first cooling passage 46a. This makes it possible to accelerate cooling of the aqueous methanol solution while slowing gas-liquid separation from moisture. Also, if the temperature of the aqueous methanol solution is not lower than the first threshold value and the amount of water in the water tank 16 is lower than the second threshold value, an adjustment is made so that the first cooling passage 46a and the second cooling passage 46b have substantially the same passage resistance. This makes it possible to cool the aqueous methanol solution while performing gas-liquid separation from moisture, thereby collecting water.

Also, if the temperature of the aqueous methanol solution is lower than the target value −α, the rpm of the entrance fan 48a and the exit fan 48b is decreased thereby reducing the amount of air supply to the first cooling passage 46a in order to raise the temperature of the aqueous methanol solution. On the other hand, if the temperature of the aqueous methanol solution is higher than the target value +α, the rpm of the entrance fan 48a and the exit fan 48b is increased thereby increasing the amount of air supply to the first cooling passage 46a thereby lowering the temperature of the aqueous methanol solution.

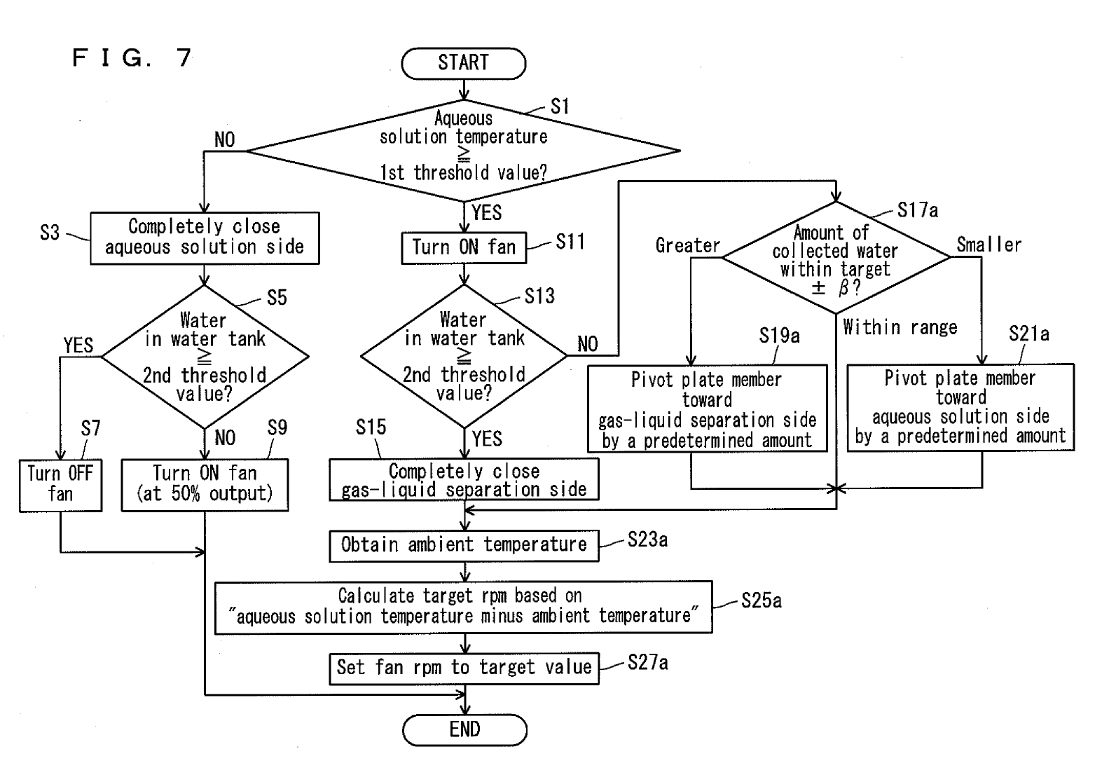

Next, Reference will be made to FIG. 7 to describe another example of operations relevant to the radiator unit 18 of the fuel cell system 10. Steps S1 through S15 are identical with those in the operation shown in FIG. 6, so these step will not be explained here.

If Step S13 determines that the amount of water in the water tank 16 is lower than the second threshold value, the CPU 86 determines whether or not the amount of water collection per a unit of time (one minute, for example) is within a range defined as a predetermined value ±β (within about 0.5 liter±about 0.1 liter, for example) (Step S17a). The amount of water collection per unit of time can be calculated accurately by taking at least the output from the cell stack 12 and the temperature of the aqueous methanol solution at the time of calculation.

If Step S17a determines that the amount of water collection is within the range of the predetermined value ±β, the process goes directly to Step S23a. If the amount of water collection is greater than the predetermined value +β, the CPU 86 takes a step to decrease the amount of air supply to the gas-liquid separation radiator 38b by controlling the servo motor 54 and pivoting the plate member 52 toward the gas-liquid separation radiator 38b by a predetermined amount (Step S19a). On the other hand, if the amount of water collection is smaller than the predetermined value −β, the CPU 86 takes a step to increase the amount of air supply to the gas-liquid separation radiator 38b by controlling the servo motor 54 and pivoting the plate member 52 toward the aqueous solution radiator 38a by a predetermined amount (Step S21a). Then, the process goes to Step S23a. The predetermined amount may be an amount of angle change in the inclination angle of the plate member 52, or an amount of change in the air flow ratio between the flow to the aqueous solution radiator and the flow to the gas-liquid separation radiator. For example, if the predetermined amount is provided by the amount of change in the inclination angle, and the actual amount is about 5 degrees, then the plate member 52 is displaced by about 5 degrees. If the predetermined amount is provided by the amount of change in the flow ratio, and the actual amount is about 5%, then the plate member 52 is pivoted so that the air flow ratio will change from, for example, 50:50 to 55:45. After performing the task in Step S15, the process also goes to Step S23a.

In Step S23a, the ambient air temperature sensor 68 obtains an ambient temperature. Then a target rpm of the entrance fan 48a and the exit fan 48b is obtained based on the “temperature of the aqueous methanol solution minus ambient temperature” (Step S25a). In this process of obtaining the target rpm, reference is made to data shown in FIG. 9 which indicates a corresponding relationship between the “temperature of aqueous methanol solution minus ambient temperature” and the fan rpm.

FIG. 9 shows data for a setting that the fan rpm is reduced with increase in the “temperature of aqueous methanol solution minus ambient temperature”. The data takes into account a fact that the larger is the value of the “temperature of aqueous methanol solution minus ambient temperature”, the more effectively can aqueous methanol solution be cooled by air which has the ambient temperature whereas the smaller is the value of the “temperature of aqueous methanol solution minus ambient temperature”, the lower is the effect of cooling the aqueous methanol solution by air which has the ambient temperature.

Then, the rpm of the entrance fan 48a and the exit fan 48b is set to a target rpm (Step S27a), and the process comes to an end.

The operation shown in FIG. 7 is repeated at a predetermined interval.

According to the fuel cell system 10 which operates as described above, water collection is accelerated by reducing the passage resistance of the second cooling passage 46b if the amount of collected water is small, and on the other hand water collection is slowed down by increasing the passage resistance of the second cooling passage 46b if the amount of collected water is large.

Also, if the “temperature of aqueous methanol solution minus ambient temperature” has a large value, the rpm of the entrance fan 48a and the exit fan 48b is reduced to decrease the amount of air supply to the first cooling passage 46a, whereby the capacity to cool the aqueous methanol solution is stabilized. This makes it possible to prevent over-cooling of the aqueous methanol solution. On the other hand, if the “temperature of aqueous methanol solution minus ambient temperature” has a small value, the rpm of the entrance fan 48a and the exit fan 48b is increased to increase the amount of air supply to the first cooling passage 46a, whereby the capacity to cool the aqueous methanol solution is stabilized. This makes it possible to prevent over heating of the aqueous methanol solution.

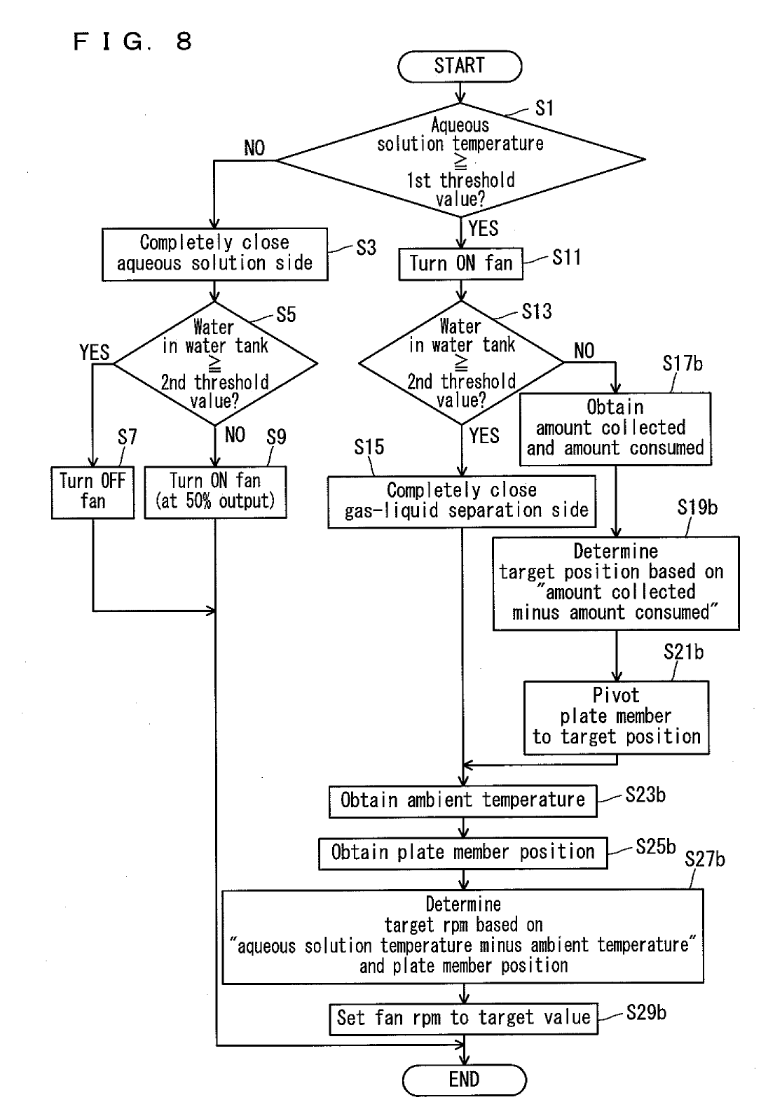

Reference will be made further to FIG. 8 to describe still another example of operations relevant to the radiator unit 18 of the fuel cell system 10. Again, Steps S1 through S15 are identical with those in the operation shown in FIG. 6, so these steps will not be explained here.

If Step S13 determines that the amount of water in the water tank 16 is lower than the second threshold value, the process obtains the amount of water collected per unit of time (one minute, for example) and the amount of water consumed per unit of time (one minute, for example) (Step S17b). The amount of water consumed per unit of time can be calculated based on a value of the electric current resulting from power generation by the fuel cell 24. The value of the electric current can be obtained based on an output from the electric current detection circuit 92. The concentration, the temperature of the aqueous methanol solution and the ambient temperature may be taken into account to calculate the amount of crossover and the amount of evaporation, based on which more accurate calculation is possible for the amount of water consumed per unit of time.

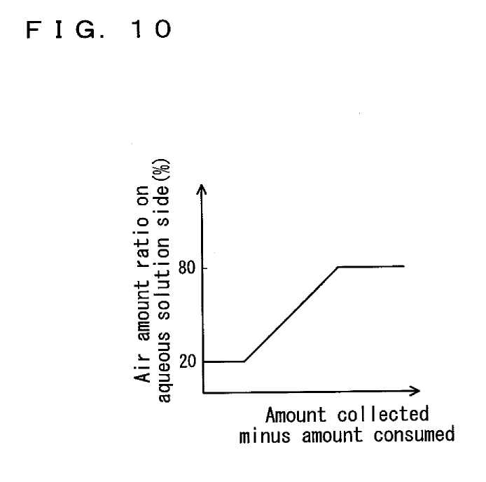

Then, based on the value of the “collected amount minus consumed amount” of water per unit of time, a target position of the plate member 52 is determined (Step S19b). In this process of determining the target position of the plate member 52, the process uses a reference data shown in FIG. 10 which indicates a corresponding relationship between the value of “collected amount minus consumed amount” of water per unit of time and a percentage of the amount of air to be sent toward the aqueous solution radiator 38a.

The data shown in FIG. 10 is for a setting that a percentage of the amount of air sent toward the aqueous solution radiator 38a is increased whereas a percentage of the amount of air sent toward the gas-liquid separation radiator 38b is decreased with increase in the value of the “collected amount minus consumed amount” of water per unit of time. In the adjustment, the air amount ratio between the aqueous solution radiator 38a and the gas-liquid separation radiator 38b is varied within a range from 20:80 through 80:20.

Thus, Step S19b makes reference to FIG. 10, and determines the ratio of the amount of air to be sent toward aqueous solution radiator 38a in accordance with the value of the “collected amount minus consumed amount” of water per unit of time, and based on this the step obtains the target position of the plate member 52. Then, the plate member 52 is pivoted to the target position (Step S21b), and the process goes to Step S23b. The process also goes to Step S23b after finishing the task in Step S15.

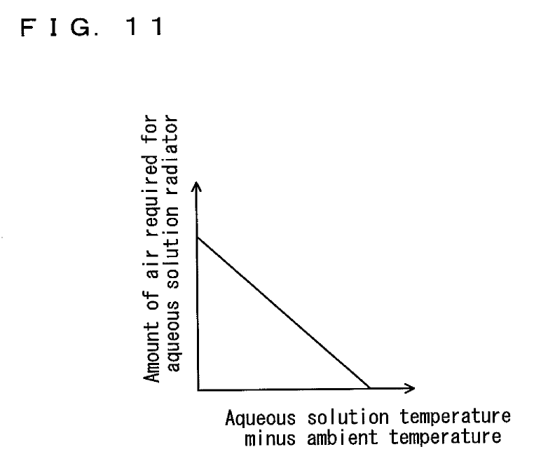

In Step S23b, the ambient air temperature sensor 68 obtains an ambient temperature. Next, the position detection sensor obtains a position of the plate member 52 (Step S25b). Then, an amount of air necessary for the aqueous solution radiator 38a is obtained based on the value of “temperature of aqueous methanol solution minus ambient temperature”. In this process of obtaining the amount of air necessary for the aqueous solution radiator 38a, the process uses a reference data shown in FIG. 11, which indicates a corresponding relationship between the value of “temperature of aqueous methanol solution minus ambient temperature” and the amount of air necessary for the aqueous solution radiator 38a.

The data shown in FIG. 11 is for a setting that the amount of air necessary for the aqueous solution radiator 38a becomes smaller as the value of “temperature of aqueous methanol solution minus ambient temperature” becomes larger. This takes into account a fact that the larger the value of the “temperature of aqueous methanol solution minus ambient temperature”, the more effectively the aqueous methanol solution can be cooled by air which has the ambient temperature.

Then, based on the obtained amount of air and the position of the plate member 52, a target rpm of the entrance fan 48a and the exit fan 48b is determined (Step S27b). The target rpm of the entrance fan 48a and the exit fan 48b is obtained as follows, for example.

First, the process obtains an rpm A, which is the number of revolutions per minute of the entrance fan 48a and the exit fan 48b required to supply the above-described obtained amount of air only to the aqueous solution radiator 38a with the gas-liquid separation radiator 38b being completely closed. Then, an air supply amount ratio between the aqueous solution radiator 38a and the gas-liquid separation radiator 38b at the actual position of the plate member 52 is taken into account. For example, if the air supply amount ratio between the two radiators is expressed as a ratio of an amount of supply for cooling the aqueous solution to an amount of supply for gas-liquid separation, and is given as 40:60, then a target rpm B for the entrance fan 48a and the exit fan 48b is given by the following formula: rpm A×100/40.

Then, the entrance fan 48a and the exit fan 48b are set to the obtained target rpm (Step S29b), and the process comes to an end.

The operation shown in FIG. 8 is performed repeatedly at a predetermined interval.

According to the fuel cell system 10 which operates as described above, the amount of water to be collected is decreased by increasing the passage resistance of the second cooling passage 46b and by decreasing the passage resistance of the first cooling passage 46a if the value of the “collected amount minus consumed amount” of water per unit of time is large. On the other hand, if the value of the “collected amount minus consumed amount” of water per unit of time is small, the passage resistance of the second cooling passage 46b is decreased and the passage resistance of the first cooling passage 46a is increased in order to accelerate water collection.

Also, the process obtains an amount of air to be supplied to the first cooling passage 46a based on the “temperature of aqueous methanol solution minus ambient temperature”, and then obtains an rpm of the entrance fan 48a and the exit fan 48b for achieving the amount of supply based on the position of the plate member 52. This makes it possible to further stabilize the capacity to cool the aqueous methanol solution.

It should be noted here that the operation of the plate member 52 in Step S3 in FIG. 6 through FIG. 8 is not limited to a complete closure of the intake opening of the aqueous solution radiator 38a. For example, the plate member 52 may be moved to any desired position to make the passage resistance of the first cooling passage 46a greater than the passage resistance of the second cooling passage 46b.

Also, the rpm of the entrance fan 48a and the exit fan 48b in Step S9 in FIG. 6 through FIG. 8 is not limited to the predetermined value described earlier, but may be adjusted based on the “temperature of aqueous methanol solution minus ambient temperature”.

Further, the operation of the plate member 52 in Step S15 in FIG. 6 through FIG. 8 is not limited to a complete closure of the intake opening of the gas-liquid separation radiator 38b. For example, the plate member 52 may be moved to any desired position to make the passage resistance of the first cooling passage 46a smaller than the passage resistance of the second cooling passage 46b.

The plate member is not limited to the plate member 52 shown in FIG. 5.

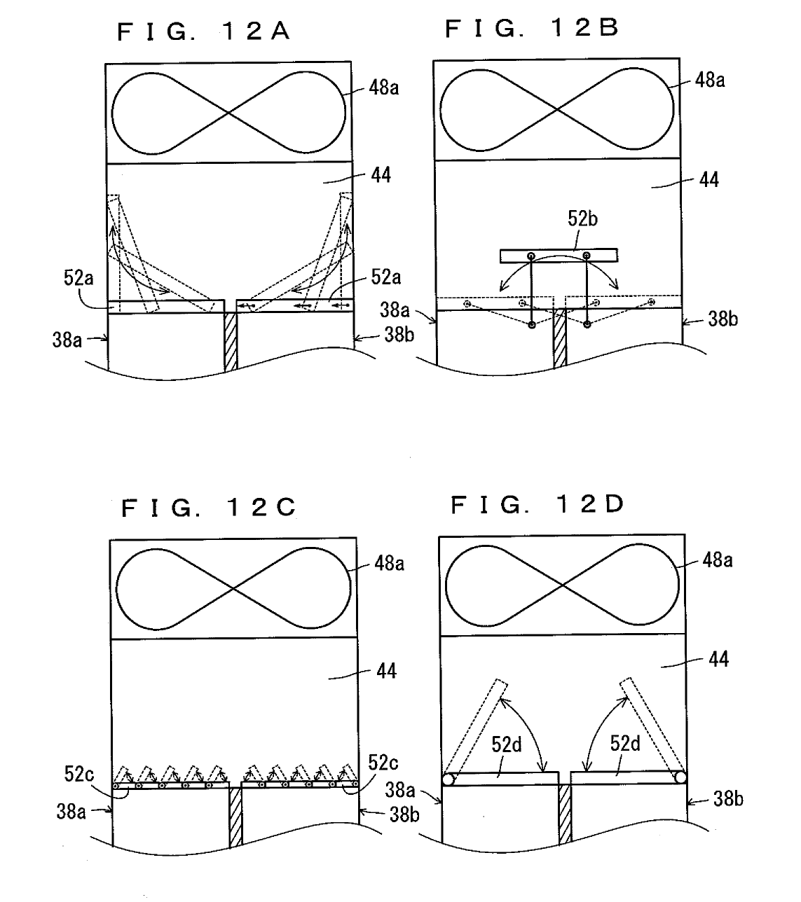

For example, as shown in FIG. 12A, a plate member 52a may be provided on each of an upper surface of the aqueous solution radiator 38a and an upper surface of the gas-liquid separation radiator 38b. In this arrangement, an end of the plate member 52a slides on the upper surface of the radiator 38a whereby the upper surface of the radiator 38a is opened and closed by one of the plate member 52a. The position of the plate member 52a represents a degree of opening/closing of the upper surface of the radiator 38a. The same applies to the radiator 38b.

As another example, a plate member 52b may be provided as shown in FIG. 12B. The plate member 52b is supported at two points, disposed in the inflow passage 44, and is capable of swinging between the upper surface of the aqueous solution radiator 38a and the upper surface of the gas-liquid separation radiator 38b. The position of the plate member 52b sets a degree of opening/closing of each of the upper surface of the radiator 38a and the upper surface of the radiator 38b.

Further, as shown in FIG. 12C, a plurality (preferably five in this example) of plate members 52c may be provided on each of the upper surface of the aqueous solution radiator 38a and the upper surface of the gas-liquid separation radiator 38b. In this arrangement, each of the plate members 52c pivots on the upper surface of the radiator 38a using one of their ends as a pivotal hinge whereby the upper surface of the radiator 38a is opened and closed by the plate members 52c. The positions of the plate members 52c represent a degree of opening/closing of the upper surface of the radiator 38a. The same applies to the radiator 38b.

Also, as shown in FIG. 12D, the plate member 52d may be provided on each of the upper surface of the aqueous solution radiator 38a and the upper surface of the gas-liquid separation radiator 38b. In this arrangement, one of the plate members 52d pivots on the upper surface of the radiator 38a using one of its ends as a pivotal hinge, whereby the upper surface of the radiator 38a is opened and closed by the plate member 52d. The position of the plate member 52d represents a degree of opening/closing of the upper surface of the radiator 38a. The same applies to the radiator 38b.

In the above-described preferred embodiments, description was made for a case where air is preferably supplied directly to outer circumferences of the radiator pipes 40a and 40b. However, the present invention is not limited to this although the present invention requires that there is a supply of fluid to the outer circumference side of the radiator pipes 40a and 40b, i.e., of the first pipe and of the second pipe. The radiator pipes 40a and 40b may be covered, for example, by a member so that a fluid is supplied on an outer surface of this member to cool the member thereby cooling the radiator pipes 40a and 40b.

As for the fluid supply unit, the present invention is not limited to the case where both of the entrance fan 48a and the exit fan 48b are provided. Only one of them may be provided. For example, if outside air can be introduced easily into the inflow passage 44 without relying upon the air duct 56, there is no need for the entrance fan 48a. The fluid supply unit is not limited to fans, but may be provided by any appropriate component, such as a pump, which is capable of sending a fluid.

The fluid which is introduced into the radiator unit 18 is not limited to air, but may be provided by whatever fluid.

Examples include gaseous fluids such as nitrogen, and liquiform fluid such as water. When using a liquid as the fluid, the fluid supply unit is preferably provided by pumps in place of the entrance fan 48a and the exit fan 48b, and the fluid temperature obtaining unit is provided by a fluid temperature sensor in place of the ambient temperature sensor 68.

The temperature sensor 28 may be provided near the anode outlet A2 so that it detects a temperature of aqueous methanol solution discharged from the anode outlet A2 of the cell stack 12.

The liquid temperature obtaining unit such as the liquid temperature sensor 28 is preferably provided at a discretionary place along a route from the aqueous solution tank 14, the anode inlet A1 of the cell stack 12, to the anode outlet A2 thereof.

The concentration sensor may be provided by a voltage sensor. The voltage sensor is provided near the anode inlet A1 of the cell stack 12, for example, and detects an open circuit voltage of the fuel cell 24. The concentration of aqueous methanol solution can be detected on the basis of the open circuit voltage.

The liquid temperature information regarding the temperature of aqueous methanol solution is not limited to the temperature itself of the aqueous methanol solution but may be represented by a surface temperature of the cell stack 12 or of the fuel cell 24.

The water amount information regarding the amount of water in the water tank 16 is not limited to the value detected by the level sensor 32, but may be the amount of water itself.

In the preferred embodiments described above, the fuel is preferably provided by methanol and the aqueous fuel solution is provided by aqueous methanol solution. However, the present invention is not limited to this. The fuel may be other alcoholic fuel such as ethanol, the aqueous fuel solution may be provided by other aqueous alcoholic solution such as aqueous ethanol solution.

The present invention is also applicable to fuel cell systems mounted on transportation equipment such as a motorbike, or on electronic equipment such as personal computers. Also, the present invention is applicable to stationary (non-portable) type fuel cell systems.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A fuel cell system comprising:
a fuel cell including an anode and a cathode;
a first pipe arranged to accommodate a flow of aqueous fuel solution discharged from the anode of the fuel cell;
a second pipe arranged to accommodate a flow of moisture discharged from the cathode of the fuel cell;
a cooling passage including an inflow passage arranged to accommodate an inflow of a fluid to cool the first pipe and the second pipe, a first cooling passage branching from the inflow passage and arranged to supply the fluid to an outer circumference side of the first pipe, and a second cooling passage branching from the inflow passage and arranged to supply the fluid to an outer circumference side of the second pipe;
an adjusting mechanism arranged to adjust passage resistances of the first cooling passage and the second cooling passage in the cooling passage; and
a controller arranged to control the adjusting mechanism.

2. The fuel cell system according to claim 1, further comprising a fluid supply unit arranged to supply the fluid to the outer circumference side of the first pipe and to the outer circumference side of the second pipe.

3. The fuel cell system according to claim 1, wherein the adjusting mechanism includes a plate member arranged in the cooling passage to adjust the passage resistances, and a driving unit arranged to move the plate member.

4. The fuel cell system according to claim 1, further comprising:
a liquid temperature obtaining unit arranged to obtain liquid temperature information regarding a temperature of the aqueous fuel solution;
a collecting unit arranged to collect water contained in the moisture; and
a water amount obtaining unit arranged to obtain water amount information regarding an amount of water in the collecting unit; wherein
the controller is arranged to control the adjusting mechanism based on the liquid temperature information obtained by the liquid temperature obtaining unit and the water amount information obtained by the water amount obtaining unit.

5. The fuel cell system according to claim 4, wherein the controller is arranged to control the adjusting mechanism so that the passage resistance of the first cooling passage is greater than the passage resistance of the second cooling passage when the temperature indicated by the liquid temperature information is lower than a first threshold value.

6. The fuel cell system according to claim 5, further comprising a fluid supply unit arranged to supply the fluid to the outer circumference side of the first pipe and to the outer circumference side of the second pipe, wherein the controller is arranged to stop the fluid supply unit if the amount of water indicated by the water amount information is not smaller than a second threshold value, and to drive the fluid supply unit if the amount of water indicated by the water amount information is smaller than the second threshold value.

7. The fuel cell system according to claim 4, wherein the controller is arranged to control the adjusting mechanism so that the passage resistance of the first cooling passage is smaller than the passage resistance of the second cooling passage if the temperature indicated by the liquid temperature information is not lower than a first threshold value and the amount of water indicated by the water amount information is not smaller than a second threshold value.

8. The fuel cell system according to claim 4, wherein the controller is arranged to control the adjusting mechanism so that the passage resistance of the first cooling passage and the passage resistance of the second cooling passage become substantially equal to each other if the temperature indicated by the liquid temperature information is not lower than a first threshold value and the amount of water indicated by the water amount information is smaller than a second threshold value.

9. The fuel cell system according to claim 8, further comprising a fluid supply unit arranged to supply the fluid to the outer circumference side of the first pipe and to the outer circumference side of the second pipe, wherein the controller is arranged to control the fluid supply unit based on the liquid temperature information obtained by the liquid temperature obtaining unit.

10. The fuel cell system according to claim 4, wherein the controller is arranged to control the adjusting mechanism based on an amount of collected water if the liquid temperature indicated by the liquid temperature information is not lower than a first threshold value and the amount of water indicated by the water amount information is smaller than a second threshold value.

11. The fuel cell system according to claim 10, further comprising:
a fluid temperature obtaining unit arranged to obtain fluid temperature information regarding a temperature of the fluid; and
a fluid supply unit arranged to supply the fluid to the outer circumference side of the first pipe and to the outer circumference side of the second pipe; wherein
the controller is arranged to control the fluid supply unit based on the liquid temperature information obtained by the liquid temperature obtaining unit and the fluid temperature information obtained by the fluid temperature obtaining unit.

12. The fuel cell system according to claim 4, wherein the controller is arranged to control the adjusting mechanism based on an amount of collected water and an amount of water consumption if the liquid temperature indicated by the liquid temperature information is not lower than a first threshold value and the amount of water indicated by the water amount information is smaller than a second threshold value.

13. The fuel cell system according to claim 12, further comprising:
a fluid temperature obtaining unit arranged to obtain fluid temperature information regarding a temperature of the fluid;
a plate member arranged to be displaceable in the cooling passage to adjust the passage resistance; and
a fluid supply unit arranged to supply the fluid to the outer circumference side of the first pipe and to the outer circumference side of the second pipe; wherein
the controller is arranged to control the fluid supply unit based on the liquid temperature information obtained by the liquid temperature obtaining unit, fluid temperature information obtained by the fluid temperature obtaining unit, and a position of the plate member.
